(19) United States
(12) Patent Application Publication
(10) Pub. No.: US 2016/0292282 A1
(43) Pub. Date: Oct. 6, 2016

(54) DETECTING AND RESPONDING TO SINGLE ENTITY INTENT QUERIES

(71) Applicant: MICROSOFT TECHNOLOGY LICENSING, LLC, Redmond, WA (US)

(72) Inventors: Ankur KHATOR, Redmond, WA (US); Nikola LETIC, Redmond, WA (US); Mihai NEGREA, Timisoara (RO); Sameer MUTATKAR, Sammamish, WA (US); Ionut-Cozmin BANTEA, Bellevue, WA (US)

(21) Appl. No.: 14/676,736

(22) Filed: Apr. 1, 2015

(51) Int. Cl. G06F 17/30

(52) U.S. Cl. CPC G06F 17/30867; G06F 17/3053; G06F 17/3087

(57) ABSTRACT

Systems and methods are presented to respond to a search query that is determined to be a single entity intent search query, i.e., the intent of the requesting computer user is information regarding a single entity. Upon receiving the search query, search results relevant to the query are identified, where each of the search results are scored according to their relevancy to the received search query. An evaluation is made as to whether the search query is a single entity intent search query. Upon determining that the search query has a single entity intent, the obtained search results are truncated to the most relevant search result, and a search results page corresponding to the most relevant search result is generated and returned to the requesting computer user.

### BACKGROUND

When a person submits a search query (via a computing device) to a search engine, that person expects search results that are highly relevant to the search query. Correspondingly, when a search engine receives a search query from a person, the search engine identifies search results that it deems to be the most relevant to the search query. Unfortunately, what a person might view as relevant search results can be different from what the search engine might determine to be relevant search results. This is especially true for local search queries, i.e., search queries directed to a specific entity at a specific geographic location.

### SUMMARY

The following Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

According to aspects of the disclosed subject matter, systems and methods are presented to respond to a search query that is determined to be a single entity intent search query, i.e., the intent of the requesting computer user is information regarding a single entity. Upon receiving the search query, search results relevant to the query are identified, where each of the search results are scored according to their relevancy to the received search query. An evaluation is made as to whether the search query is a single entity intent search query. Upon determining that the search query has a single entity intent, the obtained search results are truncated to the most relevant search result, and a search results page corresponding to the most relevant search result is generated and returned to the requesting computer user.

According to additional aspects of the disclosed subject matter, a method and computer-readable media for responding to a search query from a computer user is presented. The method includes the steps of receiving a search query from the computer user. Upon receipt of the search query, a plurality of search results are identified, the search results being relevant to the search query. A determination is made as to whether the search query is a single entity intent search query. Upon determining that the search query is a single entity intent search query, a search results page is generated according to the most relevant search result, and the search results page is returned to the requesting computer user.

According to additional aspects of the disclosed subject matter, a computer system for responding with search results to a search query is presented. The computer system comprises a processor and a memory, where the processor executes instructions stored in the memory as part of or in conjunction with additional components to respond to a search query. These additional components include a search results retrieval component, a white list of synthesized search queries corresponding to single entity intent queries, a search query evaluator, and a search results page generator. In operation, the search results retrieval component obtains a plurality of search results relevant to a received search query from a requesting computer user. These obtained search results are scored according to their relevance to the received search query. The search query evaluator evaluates whether the received search query is a single entity intent search query by matching the received search query against the synthesized search queries of the white list. Upon determining that the received search query is a single entity intent search query, the search results page generator generates a search results page according to the most relevant search result of the plurality of obtained search results relevant to the search query, which search results page is returned to the requesting computer user.

According to additional aspects of the disclosed subject matter, a computer system for responding with search results to a search query is presented. The computer system comprises a processor and a memory, where the processor executes instructions stored in the memory as part of or in conjunction with additional components to respond to a search query. These additional components include a search results retrieval component, a search query classification component, and a search results page generator. In operation, the search results retrieval component obtains a plurality of search results relevant to a received search query from a requesting computer user. These obtained search results are scored according to their relevance to the received search query. The search query classification component determines whether the received search query is a single entity intent search query. Upon determining that the received search query is a single entity intent search query, the search results page generator generates a search results page according to the most relevant search result of the plurality of obtained search results relevant to the search query, which search results page is returned to the requesting computer user.

### BRIEF DESCRIPTION OF THE DRAWINGS

The foregoing aspects and many of the attendant advantages of the disclosed subject matter will become more readily appreciated as they are better understood by reference to the following description when taken in conjunction with the following drawings, wherein:

FIG. 1 is a block diagram illustrating an exemplary environment 100 suitable for implementing aspects of the disclosed subject matter;

FIG. 2 is a flow diagram illustrating an exemplary routine for responding to a single intent search query with information corresponding to the desired single entity;

FIG. 3 is a flow diagram illustrating an exemplary routine for determining whether a received search query is a single entity intent search query;

FIG. 4 is a flow diagram illustrating an exemplary routine suitable for generating a search results page according to aspects of the disclosed subject matter;

FIG. 5 is a block diagram illustrating an exemplary process suitable for generating a white list of single entity intent search queries according to various aspects of the disclosed subject matter;

FIG. 6 is a pictorial diagram illustrating an exemplary search results page generated in response to a single entity intent search query from a computer user; and

FIG. 7 is a block diagram illustrating exemplary components of a search engine configured to respond to a single entity intent search query as set forth and described throughout this document.

### DETAILED DESCRIPTION

For purposes of clarity and definition, the term “exemplary,” as used in this document, should be interpreted as serving as an illustration or example of something, and it should not be interpreted as an ideal and/or a leading illustration of that thing. Stylistically, when a word or term is followed by “(s)”, the meaning should be interpreted as indicating the singular or the plural form of the word or term, depending on whether there is one instance of the term/item or whether there is one or multiple instances of the term/item. For example, with regard to a record that may list one or more web sites, the term “web site(s)” should be interpreted in the context of the record: that there may be a single web site listed in a record or that there may be plural web sites listed in the record.

The term “single entity intent search query” should be interpreted as a search query from a requesting computer user where the intent of the search query is in regard to a single, specific entity.

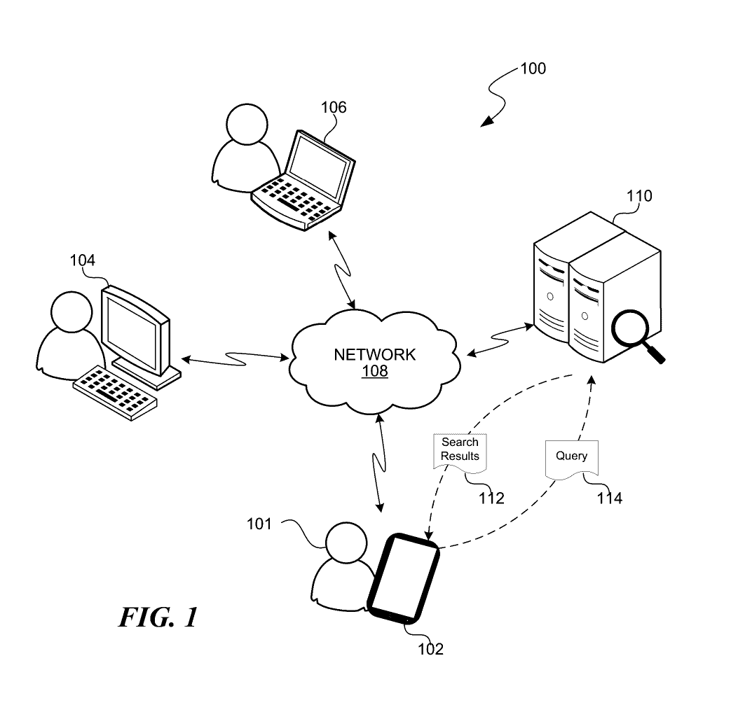

Turning to FIG. 1, this figure shows an illustrative environment 100 suitable for implementing aspects of the disclosed subject matter. The illustrative environment 100 includes one or more user computers, such as user computers 102-106, connected to a network 108, such as the Internet, a wide area network or WAN, and the like. Also connected to the network 108 is a search engine 110. Generally speaking and as will be readily appreciated by those skilled in the art, a search engine 110 corresponds to an online service that a person/computer user (such as computer user 101) may access by way of communicating with the service over the network 108. The search engine receives and responds to specific computer user communications referred to as search queries. Generally speaking, a search query identifies a particular topic for which the computer user, such as computer user 101, is requesting information. As shown by the dashed lines (to conceptually illustrate this exchange), the computer user 101 submits a search query 114 to the search engine 110. The search engine 110 identifies search results that are relevant to the search query and returns one or more search results pages, such as search results page 112, to the computer user (via the computer user's computing device 102.) The search results page(s) are displayed by a Web browser (or another program suitable for displaying content) on the computing device 102. The search results page 112 typically includes one or more search results, in the form of hyperlinks, to other locations on the network 108 in which the desired information corresponding to the search query 114 may be accessed.

As indicated, a “hyperlink” (also referred to as a “link”) is a reference to data/content at a target network site, such as a network accessible location (as identified by a Uniform Resource Locator or URL). In many instances, when displayed on a Web browser on a user computer, such as computing device 102, a hyperlink is represented or displayed as a user actionable control such that, upon activating (e.g., selecting) the “hyperlink,” the referenced content replaces the current content in the browser. In this sense, the computer user “navigates” to the network target site referenced by the hyperlink via the Web browser.

As will be readily appreciated, in response to a search query, a search engine 110 will typically identify network-accessible a plurality of references to network-accessible content relevant to the topic of the search query 114. Quite often, there are thousands, even hundreds of thousands, of references that the search engine 110 will identify as being relevant (to some degree or another) to the search result. The search engine will also score the identified results according to relevance to the query topic, as well as according to user preferences and contextual information, all to provide the most relevant search results to the requesting computer user first (i.e., the most relevant search results—as determined by the search engine—are listed before search results that are viewed as being less relevant.) Generally, a search results page will be constructed by the search engine 110 to include 10 search results referencing network-accessible content, as well as other information that may be relevant to the search query, including advertisements. Due to the blue coloration of the search results (indicating that they are user-actionable controls), these search results are often referred to as the “10 blue links.”

While the search engine 110 may view the search results 112 that are returned in response to a search query 114 as being relevant to the search query, often the computer user will view the results as not particularly relevant, especially when the user has a specific entity in mind. Indeed, if the computer user is looking for information regarding a single, specific entity, receiving 10 or thousands of search results (which may include a link to the desired specific entity) is not what the user is seeking. However, aspects of the disclosed provide a solution to this dissatisfaction. Indeed, as described in more detail below, upon receiving a search query 114, the search engine 110 determines whether the search query is directed to a single entity (i.e., that the search query is a single entity intent search query) and returns a search results page 112 directed to that single entity.

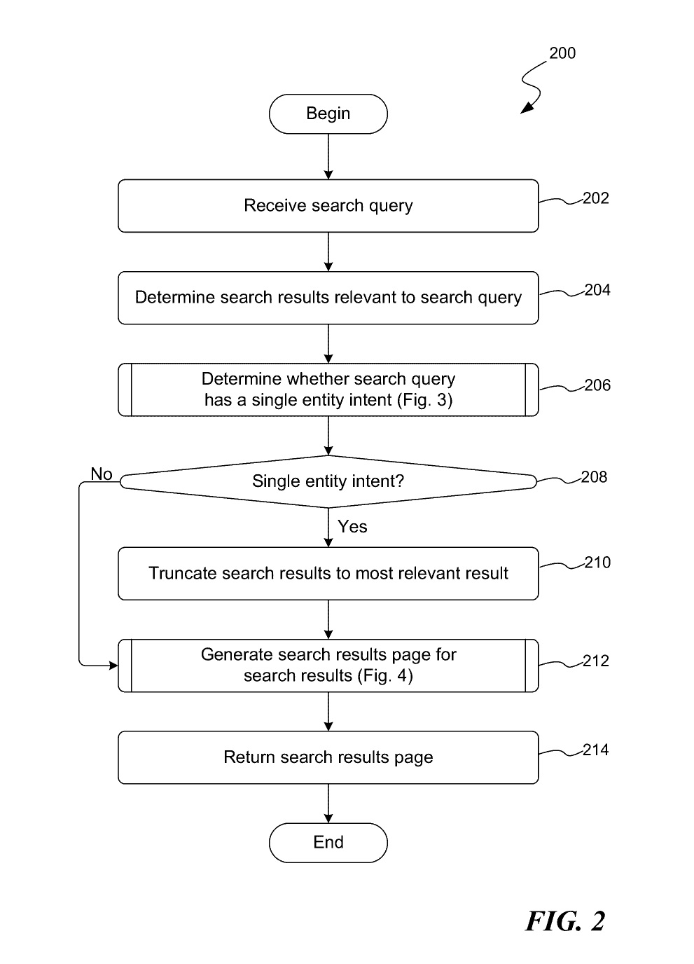

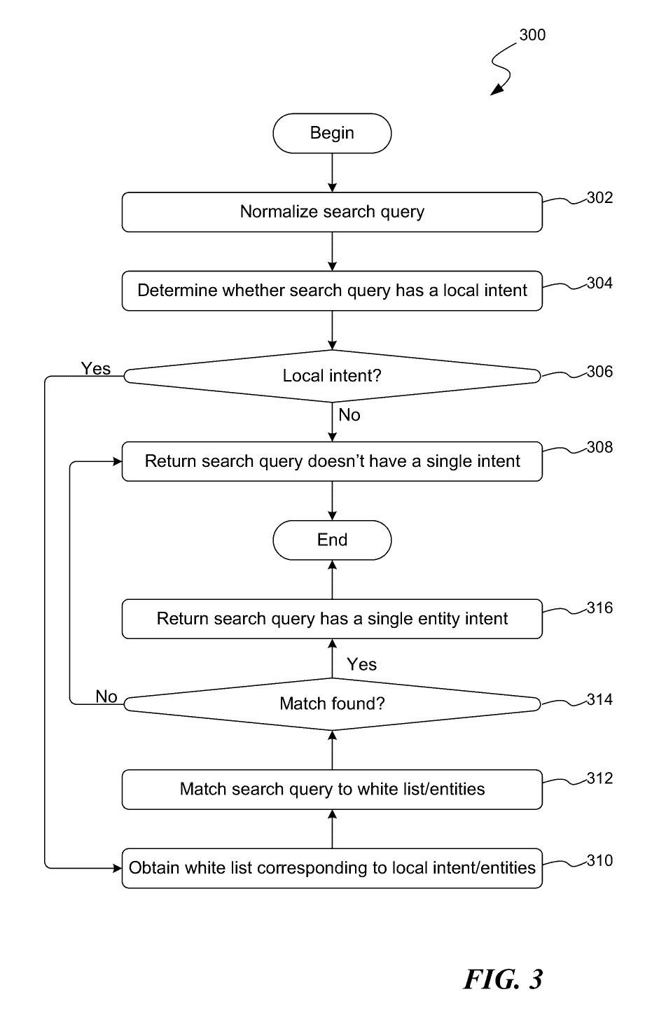

Turning to FIG. 2, FIG. 2 is a flow diagram illustrating an exemplary routine 200, as implemented by a search engine 110, for responding to a single intent search query with information corresponding to the desired single entity. Beginning at block 202, the search engine 110 receives a search query 114 from a computer user, such as computer user 101 as described above. At block 204, the search engine 110 identifies/determines a set of search results that are viewed as being relevant to the received search query. As discussed above, this set of search results may include any number of search results, and each of the set of search results are scored such that they results are ordered according to a determined relevance to the search query and requesting computer user. However, in contrast to the services of a typical search engine, according to aspects of the disclosed subject matter, at block 206 a determination is made as to whether the received search query 114 is a single entity intent search query. Determining whether the received search query 114 is a single entity intent search query is described below in regard to FIG. 3.

Turning to FIG. 3, FIG. 3 is a flow diagram illustrating an exemplary routine 300 for determining whether a received search query is a single entity intent search query. Beginning at block 302, the search query is normalized such that the elements of the search query can be readily identified. Normalizing the search query may include, by way of illustration and not limitation, converting all of the query terms to the same case, expanding abbreviations, applying user-supplied parameters to the terms, correcting typographical errors found among the query terms, identifying and/or expanding addresses of one or more query terms, and the like. Additionally, various “tokens” or words, such as stop words, articles, and the like, which are do not affect the subject matter or intent of the search query might also be removed from the received search query for purposes of matching (as described below.) At block 304, an examination of the query terms is made to determine whether the received search query 114 exhibits a local intent by the requesting computer user.

Based on the results of the examination of block 304, at decision block 306, if the received search query includes a local, specific entity intent, the routine 300 proceeds to block 310. At block 310, the search engine obtains a “white list” corresponding to specific entities within a particular location, i.e., a white list corresponding to local intent/entities. At block 312, the intent of the search query 114 is matched against the entities identified in the white list. At decision block 314, if a match is found between the identified entity of the received search query and an entity in the white list, the routine 300 proceeds to block 316. At block 316, the condition indicating that the received search query is directed to a single entity, i.e., it has a single entity intent, is returned as a result of the routine 300.

In the alternative, at decision block 306, if a local intent is not detected of the received search query 114, the routine 300 proceeds to block 308 where the condition indicating that the received search query 114 is not directed to a single entity is returned. Thereafter, the routine 300 terminates.

Returning again to FIG. 2, after analyzing the received search query 114, at decision block 208 the determination is made as to whether the received search query is a single entity intent query or not. If the search query corresponds to a single entity intent, the routine 200 proceeds to block 210. At block 210, the obtained search results that were previously determined to be relevant to the search query are truncated such that only the most relevant search result, of the set of search results, remains. Alternatively, if the search query is not a single entity and tend query, from decision block 208, the routine proceeds directly to block 212.

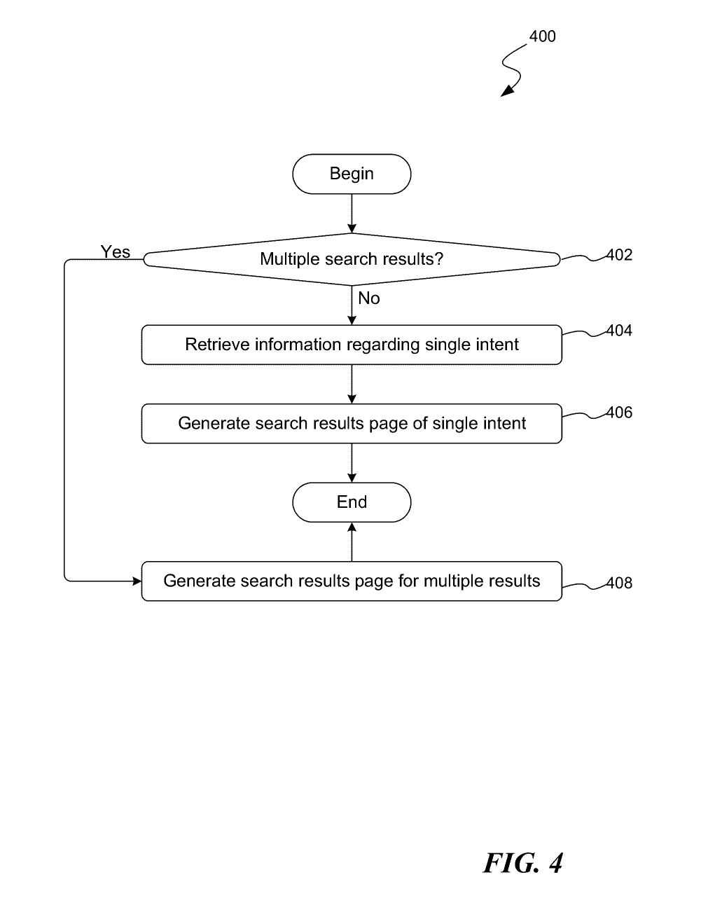

At block 212, a search results page is generated for the set of search results (either the single-most relevant search result or multiple relevant search results, as determined above.) Generating a search results page according to whether there is a single search result or a set of multiple search results is described in greater detail in regard to FIG. 4.

Turning to FIG. 4, FIG. 4 is a flow diagram illustrating an exemplary routine 400 suitable for generating a search results page according to aspects of the disclosed subject matter. Beginning at block 402, a determination is made as to whether or not there are multiple search results or a single search result (indicative of a single entity intent search query.). If there are multiple search results from which to generate one or more search results pages, the routine 400 proceeds to block 408 where at least one search results page is generated according to the multiple search results.

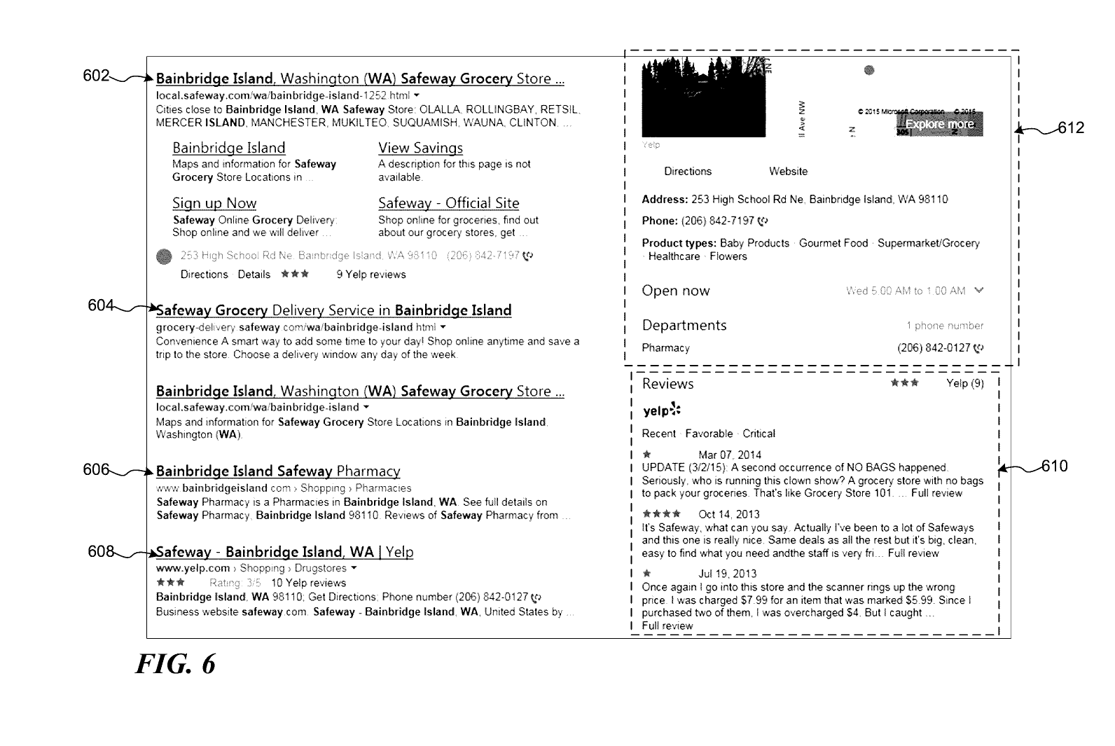

Alternatively, if at decision block 402 there is only on search result for the search query, the routine 400 proceeds to block 404. At block 404, information related to the single entity intent search result is obtained. According to aspects of the disclosed subject matter, this information related to the single entity may include links to specific web sites corresponding to the single entity. For example and with reference to FIG. 6, in addition to a hyperlink 602 to the main web site of the grocery store, Safeway, on Bainbridge Island, the resulting search results page may include additional links, such as hyperlink 604, to delivery sites corresponding to the particular store, a pharmacy (as indicated by hyperlink 606) within the store, references (such as hyperlink 608) to social reviews of the particular store as well as the content of social reviews (as indicated by box 610), entity card information (such as entity card 612) of the particular entity/store, and the like.

At block 406, a search results page is generated that corresponds to the single entity intent of the search query. Thereafter, the routine 400 terminates.

Returning again to FIG. 2, after having generated a search results page for the search result(s), at block 214 the search results page is returned to the computer user in response to the search query 114. Thereafter, the routine 200 terminates.

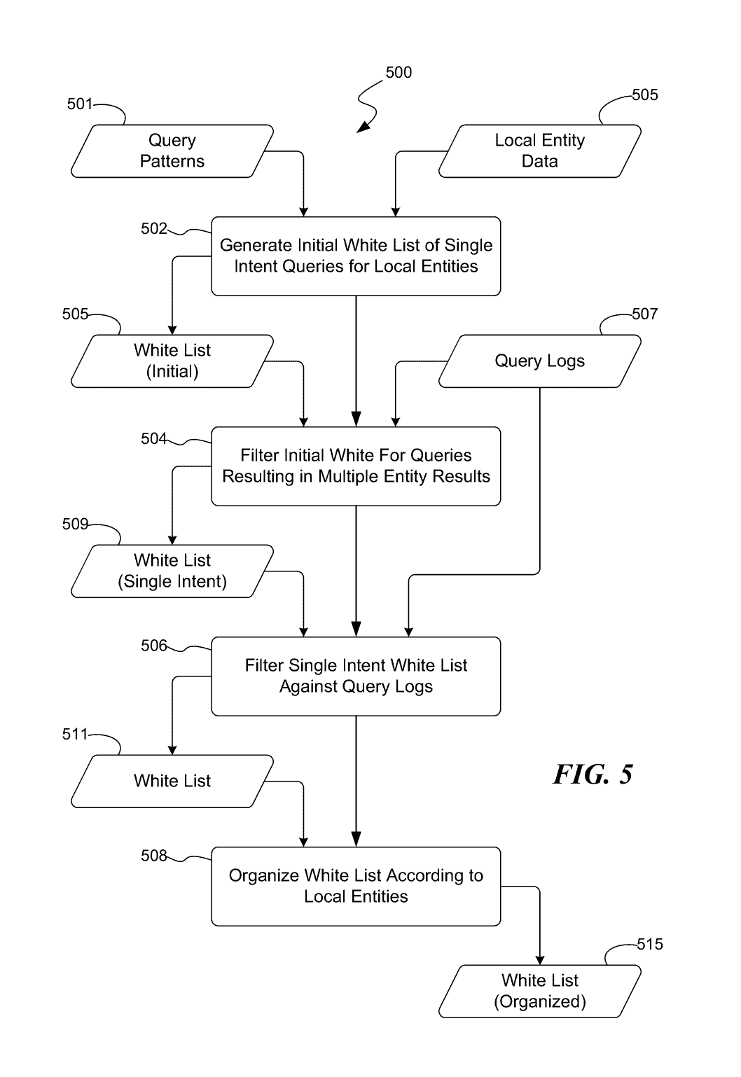

In regard to the white list of local entities mentioned above in regard to FIG. 2, FIG. 5 is a block diagram illustrating an exemplary process 500 suitable for generating the white list. The process 500 begins at block 502 where an initial white list of entities is generated according to a set of query patterns 501 and local entity data 503. Regarding the query patterns 501, this represents a set of patterns in which a search query might be presented to the search engine 110 with a single entity intent. These patterns may include, by way of illustration and not limitation: “where is <entity>,” where <entity> corresponds to a particular entity named in the search query 114 by the requesting computer user 101; “directions to <entity>;” “<entity> in <locale>,” where <locale” corresponds to the local area identified in the search query 114 by the requesting computer user 101; “<entity> <address>,” where <address> corresponds to the address of the entity; and the like. According to aspects of the disclosed subject matter, a set of synthetic search queries for each of the entities identified in the local entity data is generated for a particular location, each set including synthesized search queries of the query patterns. For example, based on the patterns listed above and for an entity called “Carrie's Café,” the set of search queries for Carrie's Café would include: “Where is Carrie's Café,” “Directions to Carrie's Café,” and “Carrie's Café in Redmond,” where “Redmond” would, for this example, be the particular location. These sets of search queries, where each set is a set of example, synthesized single entity intent search queries for the entity in a specific location, are then stored in an initial white list 505 of single entity intent search queries.

According to aspects of the disclosed subject matter, a position is that it is more important to generate a search results page that includes many search results (likely including the result that is sought) than to provide a search results page directed to a single entity that might not be the desired result of the computer user. Consequently, after having generated an initial white list 505, at block 504, the exemplary process 500 then filters the initial white list against search results of the exemplary set of search results and in light of a set of query logs that the search engine has processed. The focus of this second filtering, as suggested by block 504, is to remove those synthesized search queries that, in spite of the efforts to identify single entity intent search queries, refer to multiple entities (including multiple entities with the same name as is the case in entities of the same chain of stores). The result of this filtering is a white list 509 of synthesized, single entity intent search queries.

Again relying on the position that it is more important to generate a search results page that includes many search results (likely including the result that is sought) than to provide a search results page directed to a single entity that might not be the desired result, at block 506, the filtered white list 509 of synthesized, single entity intent search queries is again (optionally) examined against the query logs. In this case, rather than evaluating whether or not the synthesized queries relate to single search results, the white list is filtered against the query logs to retain only those synthesized search queries that were actually submitted by one or more computer users and, based on the user responses to the results, can be determined to be single entity intent queries. This filtering results in a white list 511 of synthesized, single entity intent search results that have been submitted by one or more computer users and validated (according to query logs) to be single entity intent queries.

In regard to the step of block 506, in various embodiments this step may be viewed as an optional step. In particular, there may be instances in which synthesized single entity intent search queries are desirable to be included in the white list 511.

As a final step in this process 500, at block 508, the white list 511 is processed and organized according to specific entities such that the various queries in the white list may be readily and efficiently accessed. For example, the resulting white list 515 may be organized in an indexed database according to address, entity name, location, and the like, all of which may be used as keys for quickly and efficiently matching a synthesized single entity intent search query against a received search query from a computer user to determine (as set forth in FIG. 3, block 312) if the received search query is in the resulting white list.

Regarding routines 200, 300 and 400 described above, as well as process 500 and other processes describe herein, while these routines/processes are expressed in regard to discrete steps, these steps should be viewed as being logical in nature and may or may not correspond to any actual and/or discrete steps of a particular implementation. Also, the order in which these steps are presented in the various routines and processes, unless otherwise indicated, should not be construed as the only order in which the steps may be carried out. In some instances, some of these steps, including those identified as being optional, may be omitted. Those skilled in the art will recognize that the logical presentation of steps of a routine or process is sufficiently instructive to carry out aspects of the claimed subject matter irrespective of any particular language in which the logical instructions/steps are embodied.

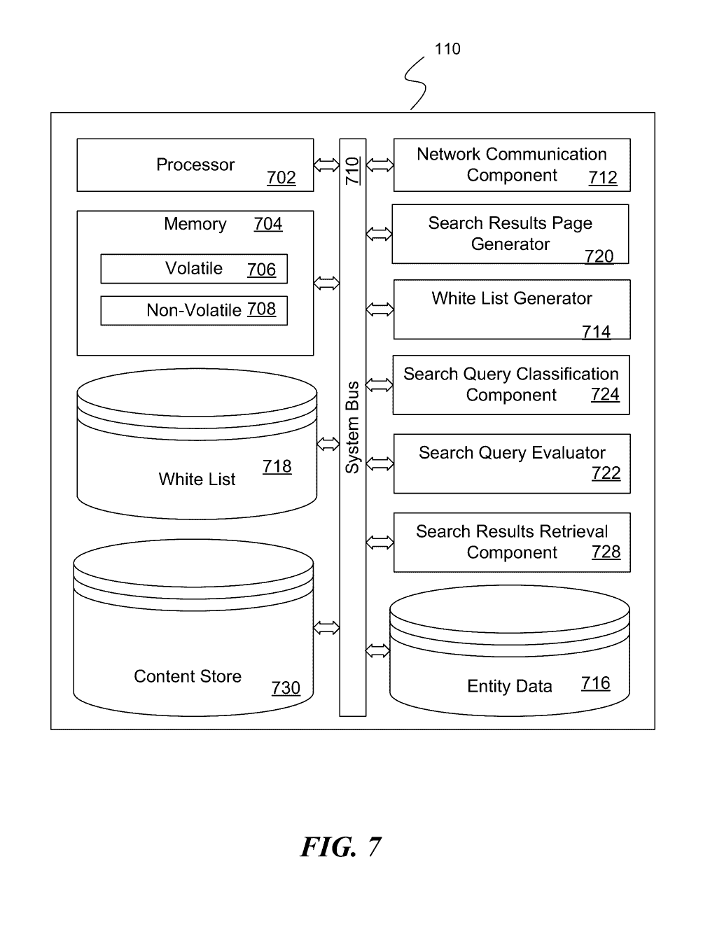

Of course, while these routines and processes include various novel features of the disclosed subject matter, other steps (not listed) may also be carried out in the execution of the subject matter set forth in these routines and processes. Those skilled in the art will appreciate that the logical steps of these routines/processes may be combined together or be comprised of multiple discrete steps. Steps of the above-described routines and processes may be carried out in parallel or in series. Often, but not exclusively, the functionality of the various routines and processes is embodied in software (e.g., applications, system services, libraries, executable modules, and the like) that is executed on one or more processors of computing devices, such as the computing device described below in regard FIG. 7. Additionally, in various embodiments all or some of the various routines may also be embodied in executable hardware modules including, but not limited to, system on chips, codecs, specially designed processors and or logic circuits, digital signal processors, and the like on a computer device or system.

As indicated, these routines/processes are typically embodied within executable code modules comprising routines, functions, looping structures, selectors such as if-then and if-then-else statements, assignments, arithmetic computations, and the like. However, the exact implementation in executable statement of each of the routines is based on various implementation configurations and decisions, including programming languages, compilers, target processors, operating environments, and the linking or binding operation. Those skilled in the art will readily appreciate that the logical steps identified in these routines may be implemented in any number of ways and, thus, the logical descriptions set forth above are sufficiently enabling to achieve similar results.

While many novel aspects of the disclosed subject matter are expressed in routines and processes embodied within applications (also referred to as computer programs), apps (small, generally single or narrow purposed, applications), and/or methods, these aspects may also be embodied as computer-executable instructions stored by computer-readable media, also referred to as computer-readable storage media, which are articles of manufacture. As those skilled in the art will recognize, computer-readable media can host, store and/or reproduce computer-executable instructions and data for later retrieval and/or execution. When the computer-executable instructions that are hosted or stored on the computer-readable storage devices are executed, the execution thereof causes, configures and/or adapts the executing computing device (or devices) to carry out various steps, methods and/or functionality, including those steps, methods, routines and processes described above. Examples of computer-readable media include, but are not limited to: optical storage media such as Blu-ray discs, digital video discs (DVDs), compact discs (CDs), optical disc cartridges, and the like; magnetic storage media including hard disk drives, floppy disks, magnetic tape, and the like; memory storage devices such as random access memory (RAM), read-only memory (ROM), memory cards, thumb drives, and the like; cloud storage (i.e., an online storage service); and the like. While computer-readable media may, in operation, deliver computer-executable instructions and/or data stored on the media to a computing device for execution via various transmission means and mediums, including transmission over carrier waves and/or propagated signals, for purposes of this disclosure computer readable media expressly excludes carrier waves and/or propagated signals.

Turning now to FIG. 7, FIG. 7 is a block diagram illustrating exemplary components of a search engine 110, as implemented on a computing device, configured to respond to a single entity intent search query as described above. The exemplary search engine 110 includes one or more processors (or processing units), such as processor 702, and a memory 704. The processor 702 and memory 704, as well as other components, are interconnected by way of a system bus 710.

The memory 704 typically (but not always) comprises both volatile memory 706 and non-volatile memory 708. Volatile memory 706 retains or stores information so long as the memory is supplied with power. In contrast, non-volatile memory 708 is capable of storing (or persisting) information even when a power supply is not available. Generally speaking, RAM and CPU cache memory are examples of volatile memory 706 whereas ROM, solid-state memory devices, memory storage devices, and/or memory cards are examples of non-volatile memory 708.

The exemplary search engine further includes a network communication component 712 for interconnecting this search engine 110 with other devices over a computer network 108, such as user computing devices 102-106. The network communication component 712, which is sometimes referred to as a network interface card or NIC, communicates over a network using one or more communication protocols via a physical/tangible (e.g., wired, optical, etc.) connection, a wireless connection, or both. As will be readily appreciated by those skilled in the art, a network communication component, such as network communication component 712, is typically comprised of hardware and/or firmware components (and may also include or comprise executable software components) that transmit and receive digital and/or analog signals over a transmission medium (i.e., the network.)

As will be readily appreciated, the processor 702 executes instructions retrieved from the memory 704 (and/or from computer-readable media) in carrying out various functions, particularly in regard to responding to a single entity intent search query. The processor 701 may be comprised of any of a number of available processors such as single-processor, multi-processor, single-core units, and multi-core units.

The suitably configured search engine 110 further includes various executable components for responding to a single entity intent search query 114. As suggested above, the search engine may be configured to include a white list generator 714. The white list generator 714 is configured to generate a white list 718 of synthesized single entity intent search queries (as described above in regard to process 500 of FIG. 5) according to various query patterns, entity data 716, and query logs, including query logs that the search engine 110 maintains. In turn a search query evaluator 720 determines whether the received search query 114 matches (and is, therefore) a single entity intent search query of the white list 718.

As an alternative to generating a white list of single entity intent queries and according to aspects of the disclosed subject matter, the search engine 110 may employ an alternative technique: that of using a search query classification component 724 that examines the received search query to extract query features from the receive query, and from the query features makes a determination as to whether or not the received search query is a single entity intent search query. Indeed, according to aspects of the disclosed subject matter, the search query classification component 724 of a suitably configured search engine 110 makes the determination (as described in FIG. 2, block 206) regarding whether the search query has a single entity intent according to the query features. These query features include, by way of illustration and not limitation, the name of the entity (if available) and whether or not the entity is a known entity, an address of the entity if available, the location of the requesting computer user, whether the named entity belongs to a business chain of entities (i.e., multiple locations operating under the same business name), a classification of the intent of the query (i.e., whether or not the search query is directed to a physical entity), and the like. From the query features and other elements, such as search query results, the search query classification component 724 makes a variety of calculations, illustratively including: how many search results can be found in the search engine's content store 730 that are highly relevant to the search query, how similar are the search results (where many results may actually be a reference to the same entity), and how disperse are the results geographically. Additionally, similarity scores between the received search query and the identified results from the content store 730 are determined, distances from an address supplied in the received search query and/or the current location of the requesting computer user to the various relevant search results, category similarities of the search query to the relevant search results, relevance scores of the search results to the search query, and the like may be computed, normalized and evaluated according to machine learning models to determine the likelihood that the received search query is a single entity intent query. Correspondingly, if the calculated score indicates a probability that the received search query is likely (i.e., above some predetermined threshold) a single entity intent search query then the search query is treated as such as described above in regard to FIG. 2.

Still further, the illustrated search engine 110 includes a search results page generator that generates a search results page according to the obtained search results, as described above in regard to routine 400 of FIG. 4. Additionally, the search engine 110 includes a search results retrieval component 728. The search results retrieval component 728 obtains search results from the content store that are viewed as being relevant to a received search query 114. Each of the search results obtained by the search results retrieval component 728 are scored according to their relevance to the received search query. Based on this relevancy score—as discussed above—the most relevant search result may be identified, especially when it is determined that the received search query 114 is a single entity intent search query.

Regarding the various components of the exemplary search engine 110, those skilled in the art will appreciate that these components may be implemented as executable software modules stored in the memory of the computing device, as hardware modules and/or components (including SoCs—system on a chip), or a combination of the two. Moreover, in certain embodiments each of the various components may be implemented as an independent, cooperative process or device, operating in conjunction with or on one or more computer systems and or computing devices. It should be further appreciated, of course, that the various components described above should be viewed as logical components for carrying out the various described functions. As those skilled in the art will readily appreciate, logical components and/or subsystems may or may not correspond directly, in a one-to-one manner, to actual, discrete components. In an actual embodiment, the various components of each computing device may be combined together or distributed across multiple actual components and/or implemented as cooperative processes on a computer network.

While various novel aspects of the disclosed subject matter have been described, it should be appreciated that these aspects are exemplary and should not be construed as limiting. Variations and alterations to the various aspects may be made without departing from the scope of the disclosed subject matter.

What is claimed:

1. A computer-implemented method for responding to a search query from a computer user, the method comprising:
receiving a search query from the computer user;
identifying a plurality of search results relevant to the search query;
determining whether the search query is a single entity intent search query; and
upon determining that the search query is a single entity intent search query:
generating a search results page according to the most relevant search result of the plurality of identified search results relevant to the search query; and
returning the generated search results page to the requesting computer user.

2. The computer-implemented method of claim 1 further comprising providing a white list of a plurality of synthesized search queries that are single entity intent search queries, and wherein determining whether the search query is a single entity intent search query comprises determining whether the received search query matches a search query of the plurality of search queries in the white list.

3. The computer-implemented method of claim 2, wherein providing a white list of a plurality of synthesized search queries that are single entity intent search queries comprises generating a white list according a plurality of query patterns in combination with local entity data corresponding to a plurality of entities in a particular geographic location.

4. The computer-implemented method of claim 3 further comprising filtering the generated white list of claim 3 according query logs such that the plurality of synthesized search queries that reference multiple entities are removed from the white list.

5. The computer-implemented method of claim 4 further comprising filtering the filtered white list of claim 4 according query logs such that only those synthesized search queries that correspond to search queries that were submitted by a computer user are retained in the white list.

6. The computer-implemented method of claim 1, wherein determining whether the search query is a single entity intent search query comprises extracting a plurality of query features from the received search query and determining whether the search query is a single entity intent search query according to the extracted plurality of query attributes.

7. The computer-implemented method of claim 6, wherein the plurality of query features from the received search query comprises any of an entity name, whether the entity is a known entity, an address of the entity, and whether the entity belongs to a business chain of entities.

8. The computer-implemented method of claim 1, wherein generating a search results page according to the most relevant search result of the plurality of identified search results relevant to the search query comprises identifying information regarding the corresponding entity of the most relevant search result and generating the search results page according to the information regarding the most relevant search result.

9. The computer-implemented method of claim 8, wherein the identified information regarding the corresponding entity of the most relevant search result comprises a plurality of hyperlinks corresponding to various aspects of the corresponding entity of the most relevant search result, and wherein the generated search results page includes at least two of the plurality of hyperlinks corresponding to various aspects of the corresponding entity of the most relevant search result.

10. The computer-implemented method of claim 9, wherein the identified information regarding the corresponding entity of the most relevant search result comprises one or more reviews of the corresponding entity, and wherein the generated search results page includes at least some of the one or more reviews of the corresponding entity of the most relevant search result.

11. A computer-readable medium bearing computer-executable instructions which, when executed on a computing system comprising at least a processor, carry out a method for responding to a search query from a user, the method comprising:
receiving a search query from the computer user;
identifying a plurality of search results relevant to the search query;
determining whether the search query is a single entity intent search query; and
upon determining that the search query is a single entity intent search query:
generating a search results page according to the most relevant search result of the plurality of identified search results relevant to the search query; and
returning the generated search results page to the requesting computer user.

12. The computer-readable medium of claim 11, wherein the method further comprises providing a white list of a plurality of synthesized search queries that are single entity intent search queries, and wherein determining whether the search query is a single entity intent search query comprises determining whether the received search query matches a search query of the plurality of search queries in the white list.

13. The computer-readable medium of claim 12, wherein providing a white list of a plurality of synthesized search queries that are single entity intent search queries comprises generating a white list according a plurality of query patterns in combination with local entity data corresponding to a plurality of entities in a particular geographic location.

14. The computer-readable medium of claim 13, the method further comprising filtering the generated white list of claim 13 according query logs such that the plurality of synthesized search queries that reference multiple entities are removed from the white list, and filtering the filtered white list according query logs such that only those synthesized search queries that correspond to search queries that were submitted by a computer user are retained in the white list.

15. The computer-readable medium of claim 11, wherein determining whether the search query is a single entity intent search query comprises extracting a plurality of query features from the received search query and determining whether the search query is a single entity intent search query according to the extracted plurality of query attributes; and
wherein the plurality of query features from the received search query comprises any of an entity name, whether the entity is a known entity, an address of the entity, and whether the entity belongs to a business chain of entities.

16. The computer-readable medium of claim 11, wherein generating a search results page according to the most relevant search result of the plurality of identified search results relevant to the search query comprises identifying information regarding the corresponding entity of the most relevant search result and generating the search results page according to the information regarding the most relevant search result.

17. The computer-readable medium of claim 16, wherein the identified information regarding the corresponding entity of the most relevant search result comprises a plurality of hyperlinks corresponding to various aspects of the corresponding entity of the most relevant search result, and wherein the generated search results page includes at least two of the plurality of hyperlinks corresponding to various aspects of the corresponding entity of the most relevant search result.

18. The computer-readable medium of claim 16, wherein the identified information regarding the corresponding entity of the most relevant search result comprises one or more reviews of the corresponding entity, and wherein the generated search results page includes at least some of the one or more reviews of the corresponding entity of the most relevant search result.

19. A computer system for responding with search results to a search query, the system comprising a processor and a memory, wherein the processor executes instructions stored in the memory as part of or in conjunction with additional components to respond to a search query, the additional components comprising:
a search results retrieval component that, in execution on the computer system, obtains a plurality of search results relevant to a received search query from a requesting computer user, wherein the plurality of obtained search results are scored according to their relevance to the received search query;
a white list of synthesized search queries, wherein each of the synthesized search queries is a single entity intent search query;
a search query evaluator that, in execution on the computer system, evaluates whether the received search query is a single entity intent search query by matching the received search query against the synthesized search queries of the white list; and
a search results page generator that, in execution on the computer system and upon the search query evaluator determining that the received search query is a single entity intent search query:
generates a search results page according to the most relevant search result of the plurality of obtained search results relevant to the search query; and
returns the generated search results page to the requesting computer user.

20. The computer system of claim 19 further comprising a search query classification component that, in execution on the computer system, examines the received search query to extract query features from the receive query, and according to the query features and the obtained plurality of search results makes a determination as to whether or not the received search query is a single entity intent search query.
